(19) United States
(12) Patent Application Publication
(10) Pub. No.: US 2003/0237099 A1
(43) Pub. Date: Dec. 25, 2003

(54) Method of delivering multimedia data streams to subscribers of a data distribution network as well as data distribution network and distribution point therefor

(75) Inventors: Hartmut Weik, Stuttgart (DE); Markus Jenisch, Waiblingen (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/463,595

(22) Filed: Jun. 18, 2003

(30) Foreign Application Priority Data
Jun. 24, 2002 (EP) 02360189.1

(51) Int. Cl. H04N 7/173; H04N 5/50

(52) U.S. Cl. 725/129; 725/118; 725/119; 725/120; 348/731

(57) ABSTRACT

A method is disclosed for delivering multimedia data streams to subscribers of a data distribution network in which a first number of data streams of different programs are fed into a head end and thence to different lower-level distribution points, in which these data streams are converted for transmission by an analog frequency-division multiplexing technique to a number of home terminations. Each of the terminals connected to the home termination can select one or more programs by selection of a frequency channel, and output this program or these programs to a user. In addition to the first number of data streams, the lower-level distribution points each receive a second number of data streams, and they retransmit data streams of this second number of data streams, together with data streams of the first number of data streams, as analog signals over given frequency channels to the respective home terminations connected thereto. Also disclosed are a data distribution network and distribution points for carrying out the method.

### BACKGROUND OF THE INVENTION

The invention is based on a priority application EP02360189.1 which is hereby incorporated by reference.

This invention relates to a method of delivering multimedia data streams to subscribers of a data distribution network.

To deliver television and radio programs to subscribers, large coaxial cable distribution networks have been deployed in many countries. The broadband cable network known in Germany as BK 450, for example, has approximately 450,000 km of coaxial cable with about 230,000 broadband amplifiers. It makes available a bandwidth up to about 450 MHz, within which more than 40 television programs can be transmitted with a bandwidth of 7 or 8 MHz each.

Administratively, the network for delivering television and sound broadcast programs to subscribers is divided into different network levels. Upper Network Levels 1 and 2 serve to create television and sound broadcast programs and to transmit these programs up to user-located broadband cable amplifier stations (bBKVrSt), which are served by higher-level broadband cable amplifier stations over coaxial cable. Network Level 3 begins at the user-located amplifier station and ends at the home terminations or demarcation points (HÜP). Network Level 4, located predominantly on private premises in the case of large systems, begins at the demarcation points and extends to the ports in the dwellings. The networks may be large networks with a few hundred dwelling ports.

The user-located amplifier stations form the centers of the serving areas, and are comparable to the access nodes of the telephone network. They represent the boundary between Network Levels 2 and 3 and serve the serving areas of Network Levels 3 and 4. Such an amplifier station has up to 8 outputs, for example, which connect to coaxial cables that may ramify into a tree-and-branch structure to ensure blanket coverage in the serving area. Intermediate amplifier points are referred to as A amplifier points if they serve exclusively amplification purposes, or as B amplifier points if branching is additionally effected to obtain the tree structure. The individual branches of the tree are terminated by so-called C amplifiers.

Networks based on conventional coaxial technology are only designed for a bandwidth of 450 MHz. Because of the increasing number of television program providers, there is a need for additional channels. It is therefore planned to extend the usable frequency range. In Germany, for example, the usable frequency range is to be extended to 862 MHz in order to obtain 48 additional 8-MHz channels. However, transmission of the wider frequency band over the existing coaxial cable is not possible, particularly because of the frequency-dependent attenuation, which increases rapidly at high frequencies. Therefore, the coaxial cables are to be replaced with optical fibers.

However, replacing the buried cables in the last short section of the connection, in this case in the section from the C amplifiers to the home terminations, is very complicated and costly. Laying new connections only up to the C amplifiers is simple by comparison, particularly if cable systems with conduits are present. For this reason, a mixed technology is employed which is referred to as Hybrid Fiber/Coax Communication (HFCC). In this concept, only the cables up to the C amplifiers are replaced with optical fibers, and in the last section, the existing coaxial cables are used. The C amplifiers are replaced with broadband optical network terminations (BONTs).

There are increasing demands that in addition to supraregional programs, regional or local programs or services, such as city district programs, should be delivered to users of the above-described analog broadband cable network. Because of the limited (analog) channels between the above-mentioned broadband optical network terminations and the users, a broadband cable network upgraded using the above-mentioned hybrid fiber/coax communication technology, like today's broadband cable network, is frequently not sufficient for a finely granulated, locally differentiated delivery of programs or services to its users.

One possibility of eliminating the aforementioned bottlenecks is to deliver digital signals directly to the users over existing coaxial links, which require substantially less bandwidth than analog channels. Then, however, the necessary conversion to analog signals requires an additional device at the user's end, such as a set-top box.

### SUMMARY OF THE INVENTION

The object of the invention is to provide a method and suitable means which make it possible to deliver to the subscriber of a broadband cable network with analog home connections both supraregional programs and, on a selective basis, local programs without any additional devices being necessary at the user's end.

The basic idea of the invention is to feed a first number of data streams, for instance national programs, into higher-level distribution points of a hybrid fiber/coax broadband access network and, in addition, a second number of data streams, for instance local programs, into lower-level distribution points of this network. The lower-level distribution points convert these data streams such that the data can be transmitted to the respective home terminations using the analog frequency-division multiplexing technique commonly employed in conventional broadband cable networks. Each of the terminals connected to the home terminations can select one or more programs by selection of a frequency channel, and output the programs to a user in the known manner. The lower-level distribution points select given data streams from the second number of data streams, for instance according to local criteria, and transmit these data streams together with data streams of the first number over given frequency channels to the respective home terminations connected thereto.

### BRIEF DESCRIPTION OF THE DRAWINGS

Further advantageous aspects of the invention are apparent from the dependent claims and the following description.

FIG. 1 shows schematically an exemplary portion of a prior art hybrid fiber/coax broadband access network;

FIG. 2a shows schematically a distribution point according to the invention for carrying out a first variant of a method according to the invention;

FIG. 2b shows schematically a distribution point according to the invention for carrying out a second variant of a method according to the invention; and

FIG. 3 shows by way of example a frequency allocation plan in the broadband access network in accordance with a method according to the invention.

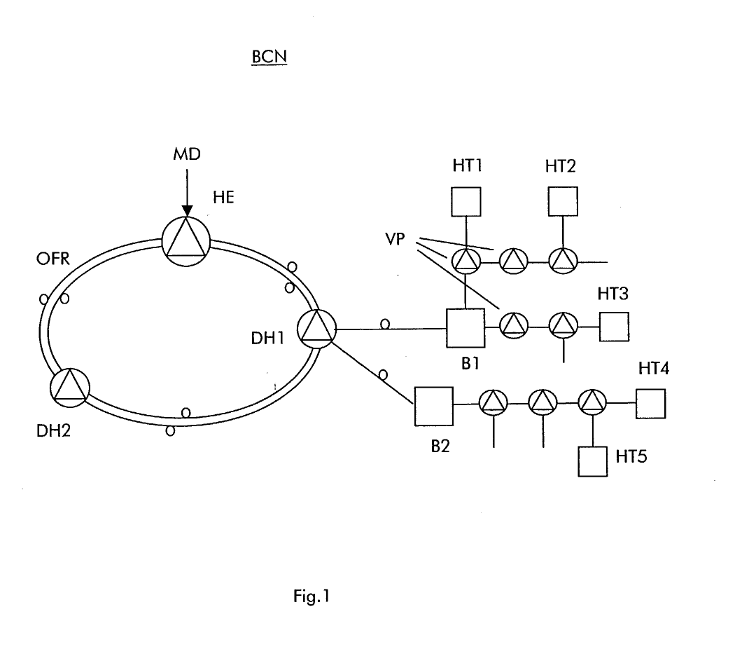

FIG. 1 shows schematically an exemplary portion of a prior-art hybrid fiber/coax broadband access network BCN of the above-mentioned Network Levels 2 and 3. A redundant optical fiber ring OFR, which forms part of Network Level 2, interconnects a head end HE and, for example, a first (user-located) distribution point DH1 (“distribution hub”) and a second (user-located) distribution point DH2. Head end HE receives multimedia data streams MD. To the first distribution point DH1, which represents the interface to Network Level 3, a first broadband optical network termination (BONT) B1 and a second broadband optical network termination B2 are connected by respective point-to-point optical fibers.

First, second, and third home terminations HT1, HT2, and HT3, for example, are connected to the first broadband optical network termination B1 via respective coaxial cables and analog amplifier points (VP), and fourth and fifth home terminations HT4 and HT5, for example, are connected to the second broadband optical network termination B2 via further coaxial cables and intermediate amplifiers.

Head end HE receives the multimedia data streams MD. These may be analog electric television signals, for example, which are converted in head end HE to digital optical signals. This is done using laser amplifiers whose light output intensity is varied linearly with the level of the transmitted signal by a modulator (intensity modulation). The light used may have a wavelength of 1300 or 1550 nm.

Since, because of the great number of subscribers, a system failure is annoying, the optical transmission network of Network Level 2 is designed as a redundant network. In many cases it is more advantageous to provide, instead of many duplicated point-to-point connections as shown in FIG. 1, a bidirectional ring OFR of two optical fibers into which the distribution points DH1 and DH2 are connected via optical splitters. With this known configuration it is possible even in case of a break in one of the fibers to provide suitable alternate circuits via the remaining fiber by means of optical switches in head end HE.

At distribution points DH1 and DH2, the signals received over optical fiber ring OFR are optically amplified and transmitted over respective optical fibers to broadband optical network terminations B1 and B2. These broadband optical network terminations B1 and B2 can be served over distances up to a few kilometers (e.g., 6 km) without intermediate amplification. In these broadband optical network terminations, the received digital optical signals are converted to analog electric signals, amplified, and transmitted as electric signals over coaxial cable, and via a number of analog (A, B, or C) amplifier points VP depending on the length of the cable connection and on the branching structure, to the respective home terminations HT1-HT5.

The upgrading of analog broadband cable networks to hybrid fiber/coax network BCN makes it possible to deliver to broadband optical network terminations B1 and B2 a number of (digital) programs which is far greater than the number of (analog) programs that can be supplied to the user-located amplifier stations in the conventional analog broadband cable network. Since even in the hybrid fiber/coax network BCN, however, the transmission from the broadband optical network terminations B1 and B2 to the terminals of the end users is still analog, only a fraction of those programs can be delivered to those end users. In particular it is not possible to deliver programs which are only of interest within a small local area, i.e., different programs for respective ones of a plurality of subareas of a serving area served by a distribution point.

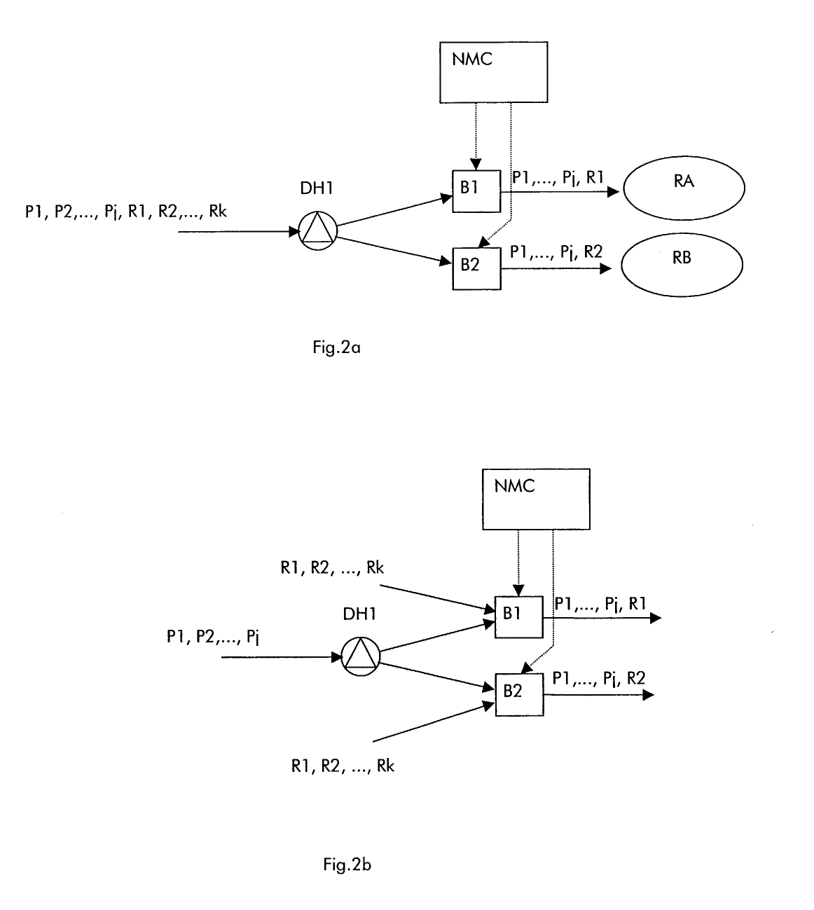

According to the invention, at least one program of interest within a small local area, henceforth called “local program”, is to be delivered to the end users in respective serving subareas of a hybrid fiber/coax network BCN without sacrificing the delivery of today's large number of supraregional or national programs. FIGS. 2a and 2b each show an embodiment of the invention.

FIG. 2a shows the first distribution point DH1 of FIG. 1 and the broadband optical network terminations B1 and B2 of FIG. 1. The first distribution point DH1 receives national programs P1, P2, . . . , Pj and local programs R1, R2, . . . , Rk and retransmits these programs to the first broadband optical network termination B1 and the second broadband optical network termination B2. The first broadband optical network termination B1 receives all national and local programs and retransmits all national programs P1-Pj and, e.g., the first local program R1 to home terminations (not shown) of a first local area RA. The second broadband optical network termination B2 routes all national programs P1-Pj and, e.g., the second local program R2 to home terminations (not shown) of a second local area RB. A network monitoring facility NMC monitors and controls the functions of the broadband optical network terminations B1 and B2.

Network monitoring facility NMC instructs each of the broadband optical network terminations B1 and B2 to select one or more given (local) programs from the received digital (local) programs and, after optical-to-electrical conversion, to allocate this program or these programs to one or more given program locations, respectively. Alternatively, this instruction or parts thereof, for instance the program positions to be occupied, may be preprogrammed in network terminations B1 and B2.

While the national programs are, as a rule, introduced into head end HE, the local programs may be fed directly into the first distribution point DH1. If this feeding is analog, the analog data are converted to digital optical data and, like the digital optical data of the national programs, sent to broadband optical network terminations B1 and B2. There, on the one hand, the optical data is converted to electrical (analog) data and, on the other hand, programs are selected from the received programs P1-Pj, R1-Rk for retransmission to the end users. In the example shown, one local program R1, R2 is selected in each network termination. These selected local programs are then put on fixed program channels, i.e., they are modulated onto given carrier frequencies. Thus, depending on the local area RA or RB, an end user receives a different local program from a fixed program position.

FIG. 2b shows an alternative embodiment in which the local programs R1-Rk are fed not into the first distribution point as in FIG. 2a, but into the broadband optical network terminations B1 and B2.

Mixed forms of the alternatives shown, in which part of the programs are fed into network elements of Network Level 2 and another part into network elements of Network Level 3 are also possible, of course. In that case, the programs to be selected need not necessarily be selected according to local interests. It is also possible to supply the end users of different regions with respective different national programs.

So far it has been assumed that the local programs are fed into distribution points DH1 and DH2 of Network Level 2 or into broadband optical network terminations B1 and B2.

It is also possible to feed local programs into amplifier points VP behind the broadband optical network terminations B1 and B2. This permits an even finer granulation of a local program supply (e.g., street television or apartment-building television in which a program with picture data of a nearby children's playground thereto is offered). A program position to be occupied by such an amplifier point VP either can be reserved by the respective broadband optical termination points or this amplifier point filters a particular program out of the entire frequency range and occupies this position with a particular local program.

In particular, an amplifier point VP may, for instance, have a receiving bandwidth up to 862 MHz and translate a digital channel from the range above 450 MHz to an analog channel in the range below 450 MHz. This method can be used in particular for local upgrading in existing networks.

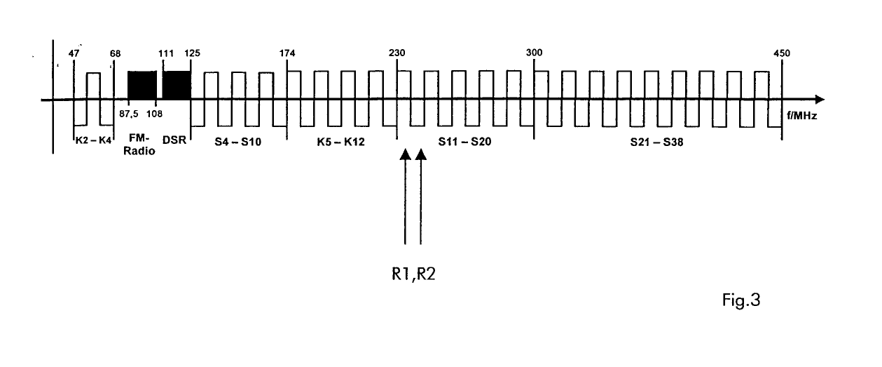

In the broadband cable network BK 450, a bandwidth up to 446 MHz is available. Its division into different frequency channels is shown in FIG. 3. The lowest band, the band below 9 MHz, is allocated for a supervisory and service channel D (not shown). Between 14.75 and 28.75 MHz, two 7-MHz reverse channels are planned, which, however, are frequently not provided in existing networks and are not shown here. The distribution program begins at 47 MHz with the three channels K2 to K4. Their band from 47 to 68 MHz is needed for upgrading the broadband cable network with a reverse channel with sufficient transmission capacity for interactive services, which, however, are still frequently used for special regional programs. At 80.5 MHz, a pilot frequency (not shown) is inserted which is necessary to control the pilot-controlled amplifiers. 87.5-108 MHz band is used for the VHF radio channels, and the 111-125 MHz band is used for the channels for Digital Satellite Radio (DSR). Between 125 and 300 MHz and from 302 to 446 MHz, twenty-five 7-MHz signals and eighteen 8-MHz channels, respectively, are available for television distribution. In a broadband cable network upgraded to 900 MHz, a plurality of further channels (not shown) are available. Two channels S11 and S12 are shown as examples of channels for local programs R1 and R2.

As described at the beginning, it is planned for many networks to extend the usable frequency range in the serving area to, e.g., 862 MHz by upgrading the respective amplifier points VP. 48 additional 8-MHz channels can then be created. Alternatively or in addiction to channels of the range below 450 MHz, channels of the range above 450 MHz can then be assigned for the delivery of local programs

1. A method of delivering multimedia data streams to subscribers of a data distribution network wherein a first number of data streams are fed through a higher-level distribution point to different lower-level distribution points which convert these data streams into a form suitable for transmission by an analog frequency-division multiplexing technique to a number of home terminations, and wherein each of the terminal devices connected to the home terminations can select one or more programs by selection of a frequency channel, and deliver the one or more programs to a user, wherein said lower-level distribution points, in addition to receiving the first number of data streams, each receive a second number of data streams, from which each of the lower-level distribution points selects one or more data streams which it then transmits, together with data streams of the first number of data streams, as analog signals over given frequency channels to the home terminations connected thereto.

2. A method as set forth in claim 1, wherein the first number and the second number of data streams are received by the lower-level distribution points in the form of optical digital signals over optical fibers and converted, by the conversion performed in the lower-level distribution points, into electric analog signals.

3. A method as set forth in claim 1, wherein the second data streams are fed into the higher-level distribution point via a separate interface.

4. A method as set forth in claim 1, wherein the second data streams are fed into lower-level distribution points via separate interfaces.

5. A method as set forth in claim 1, wherein the lower-level distribution points each receive from a network monitoring facility a request to select a given data stream of the second data streams and to allocate this data stream to a given frequency or program position for transmission to the respective home terminations connected thereto.

6. A data distribution network for distributing multimedia data streams, comprising a higher-level distribution point for feeding in a first number of data streams, lower-level distribution points for receiving these data streams, conversion means for converting the data streams for transmission by an analog frequency-division multiplexing technique, and home termination comprising receiving means for receiving the converted analog data streams, wherein each of the lower-level distribution points comprises receiving means for receiving a second number of data streams, selection means for selecting one or more data streams, and sending means for sending the selected data streams together with data streams of the first number of data streams over given frequency channels to home terminations connected to the respective lower-level distribution point.

7. A distribution point for distributing multimedia data streams, comprising receiving means for receiving a first number of digital data streams, conversion means for converting the digital signals to analog signals, and sending means for sending the analog signals via an electric interface, wherein the distribution point further comprises receiving means for receiving a second number of data streams, selection means for selecting one or more data streams, and sending means for sending the selected data streams together with data streams of the first number of data streams over given frequency channels via the electric interface.

8. A distribution point for distributing multimedia data streams, comprising receiving and sending means for receiving and sending a number of analog data streams via an electric interface, wherein the distribution point further comprises receiving means for receiving a number of digital data streams, conversion means for converting these data streams into analog electric signals, and sending means for sending data streams of the number of digital data streams together with data streams of the number of analog data streams over given frequency channels via the electric interface.
